(19) United States
(12) Patent Application Publication
(10) Pub. No.: US 2014/0298718 A1
(43) Pub. Date: Oct. 9, 2014

(54) ROOT DIRECTOR APPARATUS WITH IRRIGATION SYSTEM

(71) Applicant: Benjamin D. Gooden, Singleton (AU)

(72) Inventor: Benjamin D. Gooden, Singleton (AU)

(73) Assignee: WOODCHUCK LANDSCAPE SYSTEMS, Singleton DC (AU)

(21) Appl. No.: 14/125,811

(22) PCT Filed: Jun. 13, 2012
(86) PCT No.: PCT/AU2012/000679

§ 371 Date: Feb. 7, 2014

Related U.S. Application Data
(60) Provisional application No. 61/497,317, filed on Jun. 15, 2011.

(51) Int. Cl. A01G 29/00

(52) U.S. Cl. CPC A01G 29/00
USPC 47/32.7

(57) ABSTRACT

There is disclosed an apparatus (100) for irrigating and directing the growth of the roots of planted trees. In an embodiment, the apparatus is a generally hollow structure for encircling the roots of a planted tree, the structure having an enlarged base opening configured to allow the roots of the tree to grow downwardly, a narrower neck (108) opening configured to accommodate the trunk of the tree, and a wall (102) sloping from the enlarged base opening to a narrower wall top. An irrigation channel (110) integrally formed into the structure whereby, in use, the irrigation channel channels water around the structure to irrigate the roots of the planted tree. In an embodiment, the wall top defines a continuous shoulder (106) around the structure. An irrigation channel is formed between the continuous shoulder and the neck opening, whereby, in use, the irrigation channel channels water around the structure to irrigate the roots of the planted tree.

### CROSS-REFERENCE TO RELATED APPLICATIONS

The present application claims the benefit of U.S. Provisional Application No. 61/497,317 filed on 15 Jun. 2011, the entirety of which is incorporated herein by reference.

### FIELD

The present disclosure relates generally to structures for directing the growth of the roots of trees and plants away from surrounding pavements and walkways, and more particularly to a structure integrating an irrigation system for irrigating the roots.

### BACKGROUND

In order to improve the appearance of roadside pedestrian walkways in urban and suburban environments, trees or plants are frequently introduced into the landscape. However, given that the amount of roadside space available is often limited, the trees or plants are often surrounded by or in close proximity to pavement or stones.

Thus, it is desirable to control the growth of the tree or plant roots such that they do not damage the surrounding pavement, stones, or pipes or lines buried nearby. (For the purposes of the present discussion, for the sake of brevity, references to “tree roots” will be understood to mean “tree or plant roots”.) To control the growth of the tree roots, a root director structure may be installed when planting a tree such that the root director structure completely surrounds the tree roots, and directs the growth of tree roots in a downward direction rather than spreading out laterally or upwardly.

However, another common problem is that the pavements or stones surrounding the tree may obstruct or impede the flow of water to the tree roots (e.g. from a rainfall). While there is usually an open area immediately surrounding the base of the tree to allow for growth of the tree trunk as the tree matures, this open area may not be sufficient to provide adequate water flow to the tree roots.

What is needed is an improved root director apparatus and irrigation system which overcomes at least some of the drawbacks and limitations as described above.

### SUMMARY

The present disclosure relates to a root director apparatus with an integrated irrigation system for directing water to the roots of a tree. The irrigation system is preferably integrated into the structure of the root director apparatus, such that installation of the irrigation system is at least partially performed when the root director apparatus is installed around the roots of a tree when the tree is planted.

In an embodiment, there is provided an apparatus for irrigating and directing the growth of the roots of planted trees, the apparatus comprising: a generally hollow structure for encircling the roots of a planted tree, the structure having an enlarged base opening, a sloping wall configured to allow the roots of the tree to grow downwardly, and a narrower neck opening configured to accommodate the trunk of the tree; and an irrigation channel integrally formed into the structure whereby, in use, the irrigation channel channels water around the structure to irrigate the roots of the planted tree.

In another embodiment, there is provided an apparatus for irrigating and directing the growth of the roots of planted trees, the apparatus comprising: a generally hollow structure for encircling the roots of a planted tree, the structure having an enlarged base opening configured to allow the roots of the tree to grow downwardly, a narrower neck opening configured to accommodate the trunk of the tree, and a wall sloping from the enlarged base opening to a narrower wall top, the wall top defining a continuous shoulder around the structure; and an irrigation channel formed between the continuous shoulder and the neck opening, whereby, in use, the irrigation channel channels water around the structure to irrigate the roots of the planted tree.

In another embodiment, there is provided an apparatus for directing the growth of the roots of planted trees, the apparatus comprising: a generally hollow structure for encircling the roots of a planted tree, the structure having an enlarged base opening, a sloping wall configured to allow the roots of the tree to grow downwardly, and a narrower neck opening configured to accommodate the trunk of the tree; and vertically oriented ribs formed in the sloping wall to direct the roots of the tree downwardly.

The result is a cost-effective, highly efficient means for installing an irrigation system to irrigate tree roots surrounded by or in close proximity to pavement or stones, while at the same time controlling the growth of the tree roots to prevent damage to the surrounding pavement or stones.

### DESCRIPTION OF DRAWINGS

FIGS. 1A and 1B show exploded, perspective views of a root director apparatus with an integrated irrigation system in accordance with an embodiment;

FIGS. 2A to 2E show illustrative views of the root director apparatus of FIGS. 1A and 1B in accordance with an embodiment;

FIG. 2G shows a cross-sectional view of the root director apparatus of FIG. 2F taken at A-A;

FIGS. 3A and 3B show illustrative views of a cover ring of the root director apparatus with an integrated irrigation system of FIGS. 1A and 1B in accordance with an embodiment; and

FIGS. 4A and 4B show illustrative views of an inlet adapter of the root director apparatus with an integrated irrigation system of FIGS. 1A and 1B in accordance with an embodiment.

FIGS. 5A and 5B show illustrative views of the root director apparatus in accordance with an alternative embodiment.

### DESCRIPTION OF EMBODIMENTS

As noted above, the present disclosure relates to a root director apparatus with an integrated irrigation system for irrigating and directing growth of the roots of a tree. In a preferred embodiment, the irrigation system is integrated directly into the structure of the root director apparatus, such that installation of the irrigation system is at least partially completed when the root director apparatus is installed around the roots of a tree being planted.

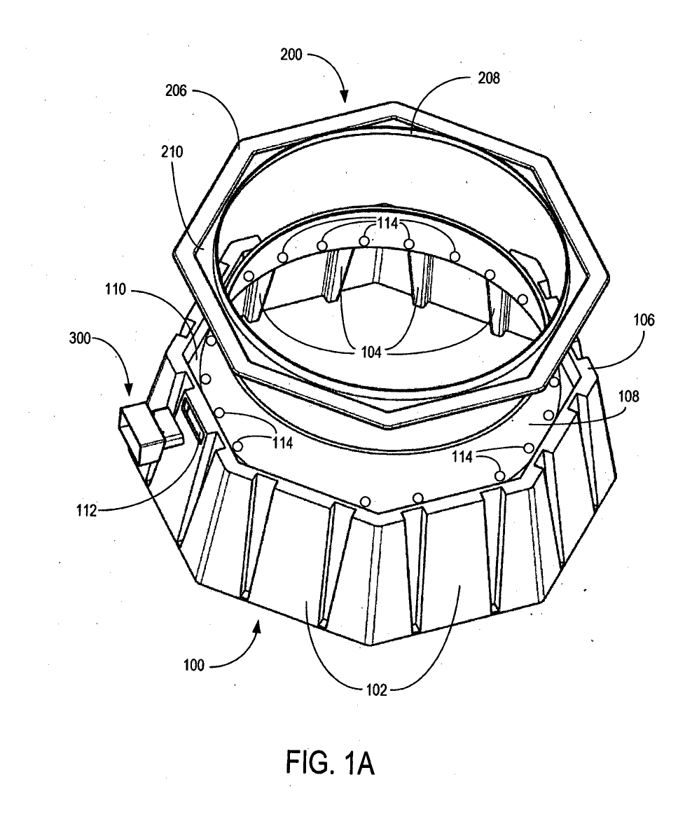

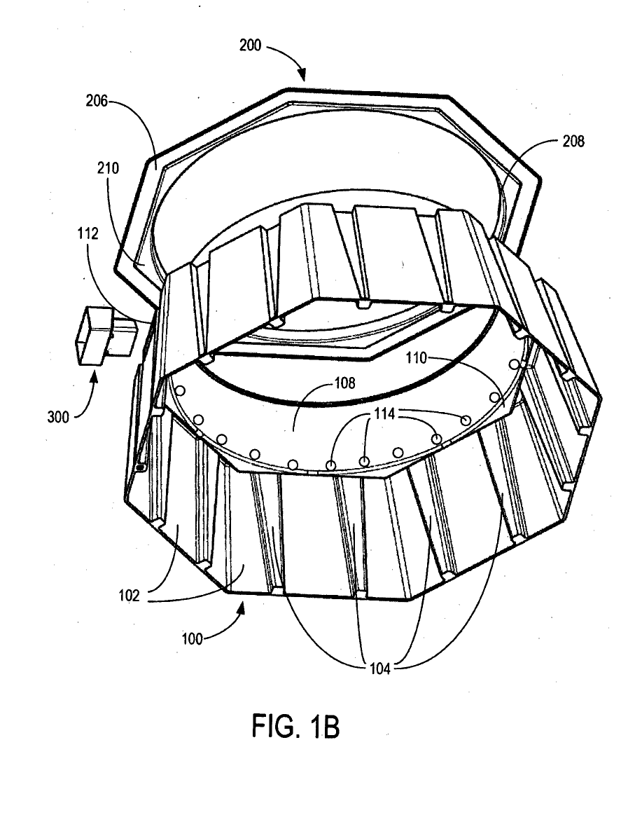

Referring to FIGS. 1A and 1B, shown are exploded, perspective views of a root director apparatus with an irrigation system in accordance with an embodiment. More particularly, FIG. 1A shows an exploded view from above, while FIG. 1B shows an exploded view from below.

In this illustrative embodiment, a root director apparatus 100 is a generally hollow structure for encircling the roots of a planted tree, and includes one or more wall sections 102 sloping from an enlarged base to a narrower top. The wall sections 102 define an enlarged base opening configured to allow the roots of the tree to grow downwardly. A narrower neck opening is configured to accommodate the trunk of the tree, and one or more defined wall sections slope from the enlarged base opening to a narrower top.

In an embodiment, each wall includes one or more vertically oriented ribs 104 formed by corresponding indentations in the outside wall 102. A wall shoulder 106 is formed along the top of each wall 102, and forms a continuous narrow ledge or shoulder running along the top of the walls 102 and around the structure. Located within the boundaries of the wall shoulders 106 is a generally frusto-conically shaped neck 108 which defines a narrower neck opening to accommodate the trunk of a tree once the tree is planted.

Still referring to FIGS. 1A and 1B, integrally formed between the wall shoulders 106 and the frusto-conically shaped neck 108 is an irrigation channel 110 which surrounds the outside of the neck 108, but remains located inside the wall shoulders 106.

As will be explained in further detail, this irrigation channel 110 is integrally formed between the continuous shoulder and the neck opening, whereby, in use, the irrigation channel channels water around the structure of the root director apparatus 100 to irrigate the roots of the planted tree. More generally, the irrigation channel is located to be in fluid communication with an aperture for a water inlet 112, which is configured to receive an inlet adapter 300 as shown.

Still referring to FIGS. 1A and 1B, shown are a plurality of apertures or holes 114 located near the base of neck 108, and near the bottom of irrigation channel 110. The illustrative holes in FIGS. 1A and 1B are not necessarily drawn to scale, and may be larger or smaller in size, and larger or smaller in number. These holes 114 may also be located at the bottom wall of irrigation channel 110, and also possibly on the inner side walls adjacent wall shoulders 106. These holes 114 in the irrigation channel 110 act as water outlets for water stored in the irrigation channel 110, and preferably should be of a size that is large enough for water to exit, but is more difficult for soil or other particles to enter into the irrigation channel 110. The number and size of holes 114 will determine the rate of drainage of water from irrigation channel 110, and should be selected such that the rate of drainage is adequate for the rate of inflow of water that may be expected from the water source via the water inlet 112, and the volume of water that irrigation channel 110 can store.

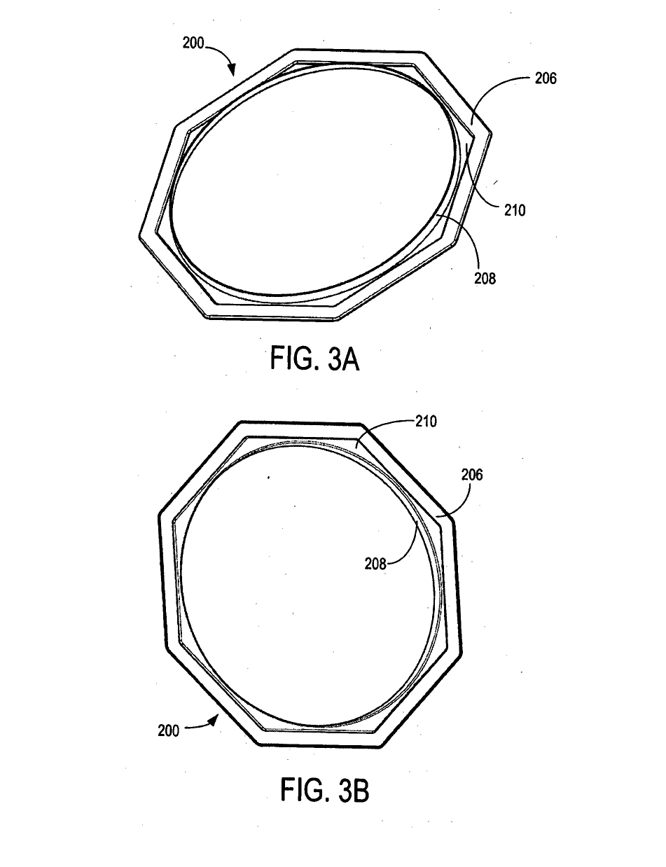

Still referring to FIGS. 1A and 1B, shown above the root director apparatus 100 is a cover ring or collar 200 shaped to be received around the neck 108 of the root director apparatus 100. Collar 200 includes a shoulder cover 206 corresponding to the size and shape of the wall shoulders 106, an irrigation channel cover 210 corresponding to the size and shape of the irrigation channel 110, and a collar rim 208 corresponding to the size and shape of the frusto-conically shaped neck 108. The purpose of the collar 200 will be described in further detail with reference to FIGS. 3A and 3B.

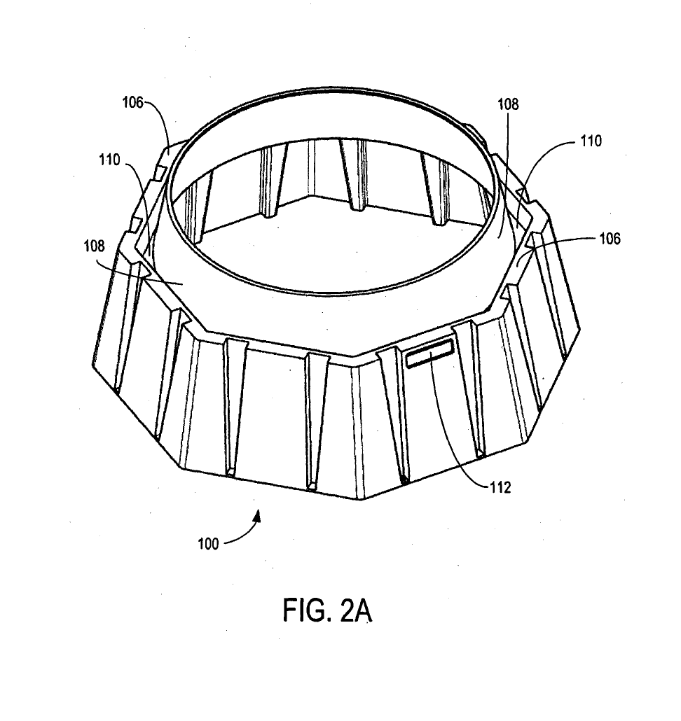

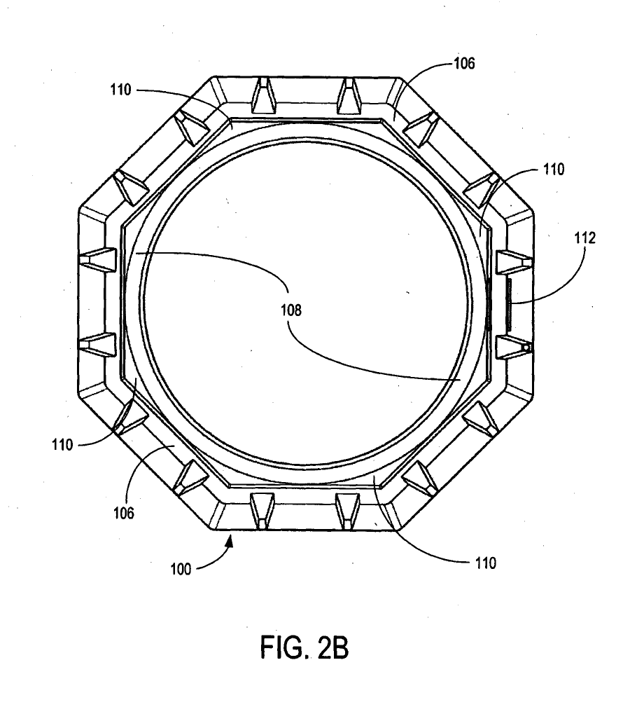

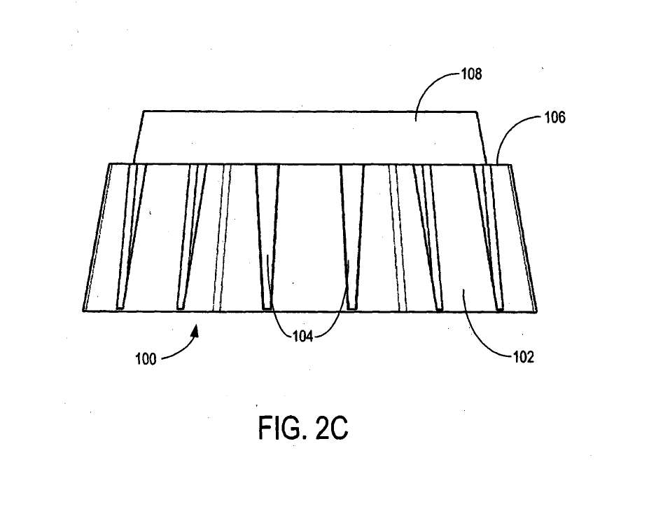

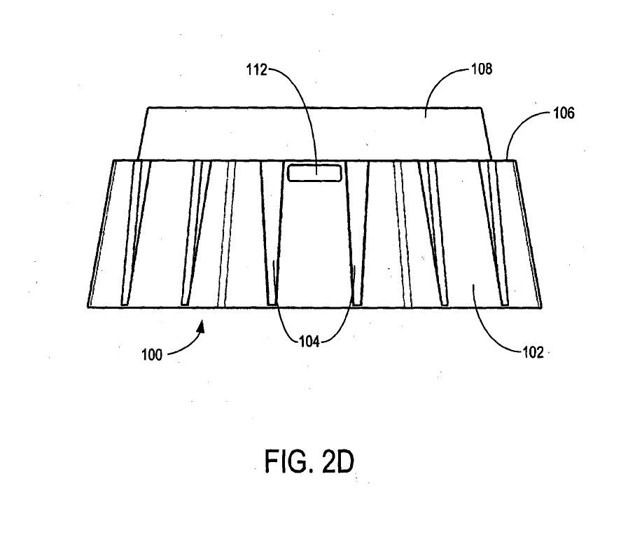

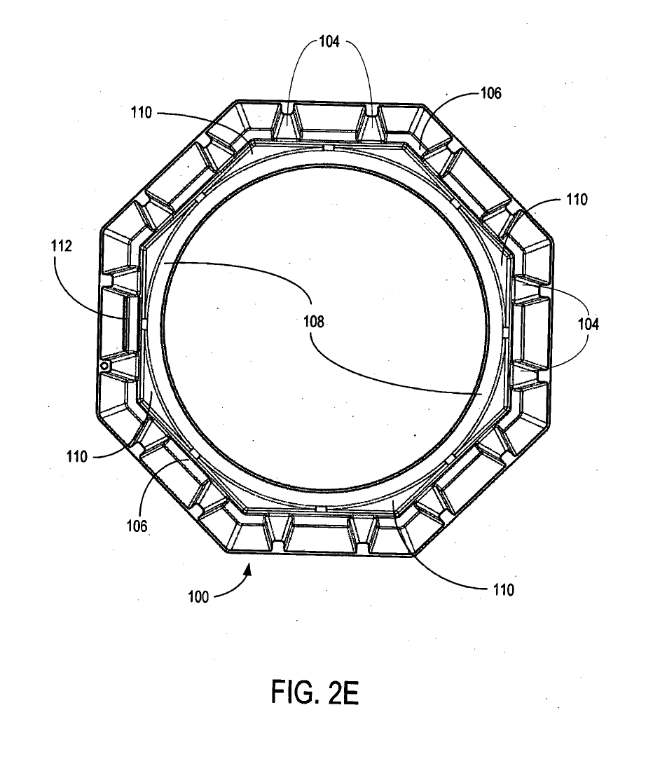

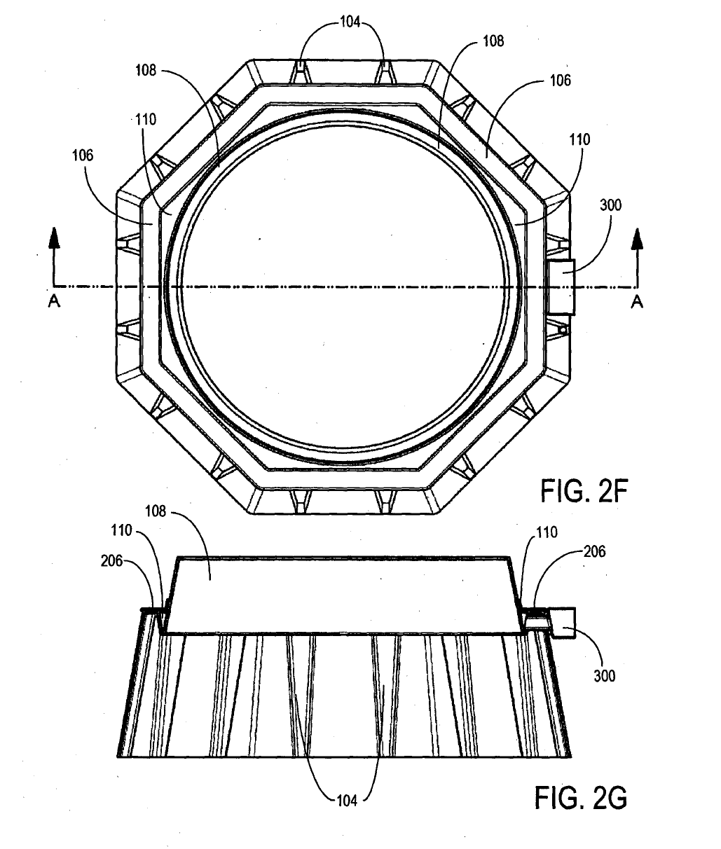

FIGS. 2A to 2E show illustrative views of the root director apparatus 100 of FIGS. 1A and 1B in accordance with an embodiment. FIG. 2A shows more clearly the location of the aperture for water inlet 112, which is positioned above or at the same level as irrigation channel 110 to which water inlet 112 is connected. Thus, as inflow of water through water inlet 112 is received in irrigation channel 110, and surrounds the neck 108 in a similar manner as a moat. FIG. 2B illustrates a top view of the root director apparatus 100 with water inlet 112 shown connected to irrigation channel 110, and irrigation channel 110 formed between neck 108 and wall shoulders 106, and surrounding neck 108 entirely.

Now referring to FIGS. 2C and 2D, shown are front and side views of the root director apparatus 100 of FIGS. 1A and 1B, where neck 108 extends above the wall shoulders 106. In this configuration, collar 200 may be slipped around neck 108 and rest on top of the wall shoulders 106 to effectively cover the irrigation channel from dirt, and other materials that may otherwise impede the flow of water within irrigation channel 110.

FIG. 2E shows an illustrative bottom view of the root director apparatus 100 of FIGS. 1A and 1B. As shown, ribs 104 extend inwardly into the center of the root director apparatus 100 and help provide structural rigidity to the walls 102. In addition, the ribs 104 help direct the growth of the tree roots downwards between adjacent ribs 104, and prevents the roots from spiraling around, which may occur without the ribs in place. As well, the slope of the walls forming an expanded base relative to the wall shoulders 106 of the root director apparatus assists in directing the growth of the tree roots downwardly, rather than laterally or upwardly.

FIG. 2G shows a cross-sectional view of the root director structure of FIG. 2F taken at A-A. As clearly shown, inlet adapter 300 is received within water inlet 112 and is in fluid communication with irrigation channel 110 formed between the wall shoulders 106 and neck 108. In this view, collar 200 is shown with shoulder cover 206 positioned directly on top of shoulders 106. While this illustrative embodiment shows a relatively narrow irrigation channel 110, it will be appreciated that the irrigation channel may be widened, for example by reducing the width of the wall shoulders 106, or making the diameter of the neck 108 smaller. In addition, irrigation channel 110 may be made deeper such that irrigation channel 110 can accommodate a larger volume of water entering via the water inlet 112. As previously described, the size, number and location of holes 114 in the irrigation channel 110 may be adapted based on the capacity of irrigation channel 110 and the expected inflow of water via water inlet 112.

Now referring to FIGS. 3A and 3B, shown are illustrative views of the collar 200 in accordance with an embodiment. As previously discussed, collar 200 has a shoulder cover 206 corresponding to the size and shape of the wall shoulders 106. Preferably, the shoulder cover 206 is sized and shaped to cover the wall shoulders 106 without any significant gaps, such that soil, sand or other materials cannot enter between them to fall into the irrigation channel 110. In addition, collar rim 208 is preferably sized and shaped to fit the frusto-conically shaped neck 108 snugly, such that soil, sand or other materials cannot enter between them to fall into irrigation channel 110. To accommodate a snug fit, in an embodiment, collar 200 may be made from a somewhat flexible, resilient material so that collar 200 can stretch around neck 108 if necessary, in order for the shoulder cover 206 to sit tightly against the wall shoulders 106. In another embodiment, collar 200 may be configured such that shoulder covers 206 can snap into place over wall shoulders 106, similar to a plastic cover snapping over a plastic container, in order to ensure that soil, sand and other materials do not enter the irrigation channel and block the flow. However, as will be explained further below, collar 200 should be removable in order to access irrigation channel 110 for maintenance if necessary.

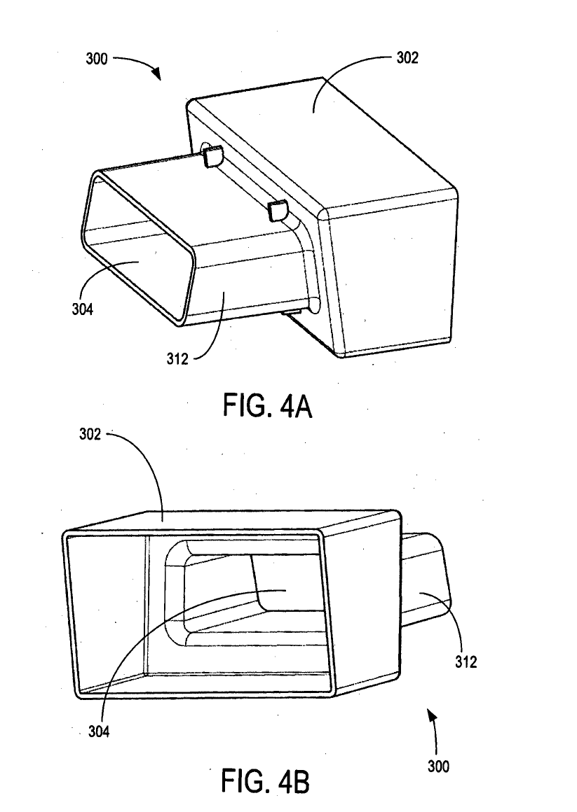

Now referring to FIGS. 4A and 4B, shown are illustrative views of an inlet adapter 300 of the root director apparatus 100 with irrigation system of FIGS. 1A and 1B in accordance with an embodiment. As shown in FIGS. 1A, 1B and 2G, inlet adapter 300 is configured to be received within water inlet 112 formed into a side of the root director apparatus 100. In order to achieve a good fit, in an embodiment, inlet adapter 300 may be made from a somewhat resilient, flexible material allowing inlet adapter 300 to be received snugly within water inlet 112. Alternatively, inlet adapter 300 may be used together with a rubber seal or gasket to assist with providing a snug fit for the inlet adapter 300 within water inlet 112. While a perfectly watertight seal may not be necessary, the seal should be such that the bulk of the water entering through the water inlet 112 via the inlet adapter 300 is directed to irrigation channel 110.

Similarly, inlet adapter 300 may be configured to provide a snug fit with a drainage pipe (not shown) coming in from an adjacent curb by a roadside, or possibly from some other source of water such as a stream or irrigation channel. Suitable filters may be provided at the mouth of the drainage pipe, or elsewhere along the pipe, to prevent soil, sand or larger particles or contaminants from entering and ultimately clogging the irrigation channel 110. Alternatively, or in addition, a goose-neck shaped portion may be provided in the drainage pipe to minimize the particulates entering into the irrigation channel 110. However, over time, it may be difficult to keep irrigation channel 110 completely free of any soil, sand or particles, and eventually some maintenance may be required to clear the irrigation channel 110 by lifting the collar 200 and removing any debris trapped inside the irrigation channel 110.

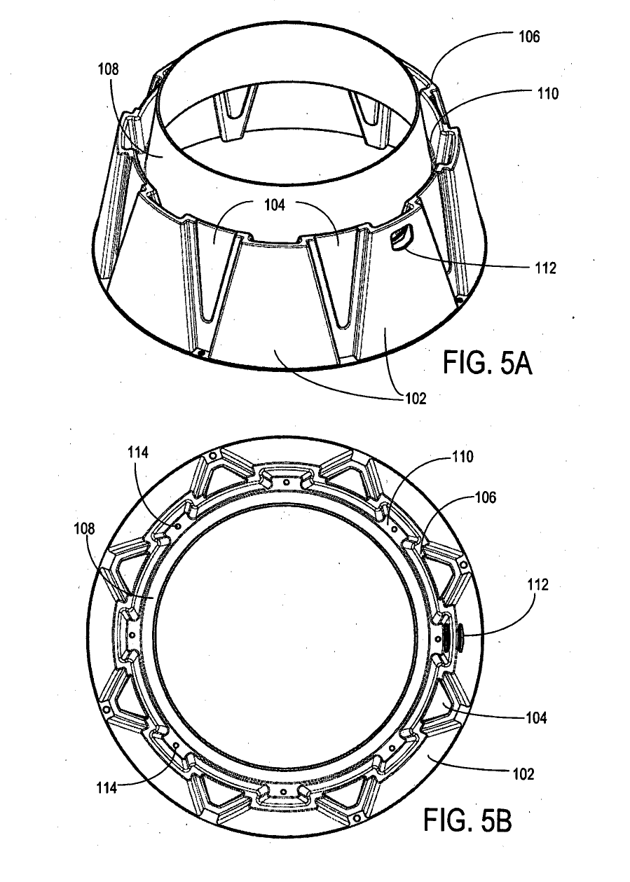

Now referring to FIGS. 5A and 5B, shown are illustrative views of the root director apparatus in accordance with an alternative embodiment. In this embodiment, the structure has walls that are generally frusto-conical in shape rather than the generally octagonal shape of the embodiment shown and described earlier. However, as shown, this alternative embodiment includes the wall sections 102, vertically oriented ribs 104, wall shoulder 106, the frusto-conically shaped neck 108, an integrally formed irrigation channel 110, and water inlet 112 as described earlier, which is configured to receive an inlet adapter 300 as shown above. Thus, it will be appreciated that the root director apparatus can be adapted to different shapes and configurations, and is not limited to the illustrative examples shown and described.

Thus, in an aspect, there is provided an apparatus for irrigating and directing the growth of the roots of planted trees, the apparatus comprising: a generally hollow structure for encircling the roots of a planted tree, the structure having an enlarged base opening, a sloping wall configured to allow the roots of the tree to grow downwardly, and a narrower neck opening configured to accommodate the trunk of the tree; and an irrigation channel integrally formed into the structure whereby, in use, the irrigation channel channels water around the structure to irrigate the roots of the planted tree.

In an embodiment, the sloping wall slopes from the enlarged base opening to a narrower wall top, the wall top defining a continuous shoulder around the structure, wherein the irrigation channel is integrally formed between the continuous shoulder and the neck opening.

In another embodiment, the apparatus further includes a collar configured to be received around the neck opening, the collar having a shoulder cover to cover the irrigation channel.

In another embodiment, the irrigation channel includes a plurality of apertures, the plurality of apertures configured to function as water outlets when the apparatus is in use.

In another embodiment, the number and size of the apertures are configured based on an expected rate of inflow of water from a water source and a desired rate of drainage.

In another embodiment, the width and depth of the irrigation channel are configured based on an expected rate of inflow of water from a water source and a desired rate of drainage.

In another embodiment, the apparatus further includes a water inlet formed into a side of the apparatus, the water inlet connectable to an irrigation channel such that, in use, the water inlet is in fluid communication with the irrigation channel.

In another embodiment, the water inlet is further adapted to receive an inlet adapter, the inlet adapter being connectable in use to a water source.

In another embodiment, the sloping wall includes vertically oriented ribs formed therein to direct the roots of the tree downwardly.

In another embodiment, the vertically oriented ribs are formed by corresponding indentations in the sloping wall.

In another embodiment, the vertically oriented ribs extend inwardly from the sloping wall.

In another aspect, there is provided an apparatus for directing the growth of the roots of planted trees, the apparatus comprising: a generally hollow structure for encircling the roots of a planted tree, the structure having an enlarged base opening, a sloping wall configured to allow the roots of the tree to grow downwardly, and a narrower neck opening configured to accommodate the trunk of the tree; and vertically oriented ribs formed in the sloping wall to direct the roots of the tree downwardly.

In an embodiment, the vertically oriented ribs are formed by corresponding indentations in the sloping wall.

In another embodiment, the vertically oriented ribs extend inwardly from the sloping wall.

In another embodiment, the apparatus further includes an irrigation channel integrally formed into the structure whereby, in use, the irrigation channel channels water around the structure to irrigate the roots of the planted tree.

In another embodiment, the sloping wall slopes from the enlarged base opening to a narrower wall top, the wall top defining a continuous shoulder around the structure, wherein the irrigation channel is integrally formed between the continuous shoulder and the neck opening.

In another embodiment, the apparatus further includes a collar configured to be received around the neck opening, the collar having a shoulder cover to cover the irrigation channel.

In another embodiment, the irrigation channel includes a plurality of apertures, the plurality of apertures configured to function as water outlets when the apparatus is in use.

In another embodiment, the number and size of the apertures are configured based on an expected rate of inflow of water from a water source and a desired rate of drainage.

In another embodiment, the width and depth of the irrigation channel are configured based on an expected rate of inflow of water from a water source and a desired rate of drainage.

While the above description provides examples of one or more systems and methods, it will be appreciated that other systems and methods may be within the scope of the present description as interpreted by one of skill in the art.

1. An apparatus for irrigating and directly the growth of the roots of planted trees, the apparatus comprising:
a generally hollow structure for encircling the roots of a planted tree, the structure having an enlarged base opening, a sloping wall configured to allow the roots of the tree to grow downwardly, the sloping wall slopes from the enlarged base to a narrower wall top, the wall top defining a continuous shoulder around the structure, and a narrower neck opening configured to accommodate the trunk of the tree; and
an irrigation channel integrally formed into the structure between the continuous shoulder and the neck opening whereby, in use, the irrigation channel channels water around the structure to irrigate the roots of the planted tree.

2. (canceled)

3. The apparatus of claim 1, wherein the apparatus further includes a collar configured to be received around the neck opening, the collar having a shoulder cover to cover the irrigation channel.

4. The apparatus of claim 1, wherein the irrigation channel includes a plurality of apertures, the plurality of apertures configured to function as water outlets when the apparatus is in use.

5. The apparatus of claim 4, wherein the number and size of the apertures are configured based on an expected rate of inflow of water from a water source and a desired rate of drainage.

6. The apparatus of claim 4, wherein a width and depth of the irrigation channel are configured based on an expected rate of inflow of water from a water source and a desired rate of drainage.

7. The apparatus of claim 1, wherein the apparatus further includes a water inlet formed into a side of the structure, the water inlet connectable to the irrigation channel such that, in use, the water inlet is in fluid communication with the irrigation channel.

8. The apparatus of claim 7 wherein the water inlet is further adapted to receive an inlet adapter, the inlet adapter being connectable in use to a water source.

9. The apparatus of claim 1, wherein the sloping wall includes vertically oriented ribs formed therein to direct the roots of the tree downwardly.

10. The apparatus of claim 9, wherein the vertically oriented ribs are formed by corresponding indentations in the sloping wall.

11. The apparatus of claim 10, wherein the vertically oriented ribs extend inwardly from the sloping wall.

12. An apparatus for directing the growth of the roots of planted trees, the apparatus comprising:
a generally hollow structure for encircling the roots of a planted tree, the structure having an enlarged base opening, a sloping wall configured to allow the roots of the tree to grow downwardly, and a narrower neck opening configured to accommodate the trunk of the tree; and
vertically oriented ribs formed by indentations in the sloping wall to direct the roots of the tree downwardly.

13. (canceled)

14. The apparatus of claim 12, wherein the vertically oriented ribs extend inwardly from the sloping wall.

15. The apparatus of claim 12, wherein the apparatus further includes an irrigation channel integrally formed into the structure whereby, in use, the irrigation channel channels water around the structure to irrigate the roots of the planted tree.

16. The apparatus of claim 15, wherein the sloping wall slopes from the enlarged base opening to a narrow wall top, the wall top defining a continuous shoulder around the structure, wherein the irrigation channel is integrally formed between the continuous shoulder and the neck opening.

17. The apparatus of claim 15, wherein the apparatus further includes a collar configured to be received around the neck opening, the collar having a shoulder cover to cover the irrigation channel.

18. The apparatus of claim 15, wherein the irrigation channel includes a plurality of apertures, the plurality of apertures configured to function as water outlets when the apparatus is in use.

19. The apparatus of claim 18, wherein the number and size of the apertures are configured based on an expected rate of inflow of water from a water source and a desired rate of drainage

20. The apparatus of claim 18, wherein a width and depth of the irrigation channel are configured based on an expected rate of inflow of water from a water source and a desired rate of drainage.
